(19) United States
(12) Patent Application Publication
(10) Pub. No.: US 2007/0070647 A1
(43) Pub. Date: Mar. 29, 2007

(54) Planar light source and liquid crystal display apparatus

(76) Inventors: Chu-Chi Ting, Hualien City (TW); Te-Chu Lu, Bade City (TW); Chin-Cheng Chien, Jhongli City (TW)

Correspondence Address: J C PATENTS, INC., 4 VENTURE, SUITE 250, IRVINE, CA, 92618, US

(21) Appl. No.: 11/236,968

(22) Filed: Sep. 27, 2005

(51) Int. Cl. F21V 7/04

(52) U.S. Cl. 362/600

(57) ABSTRACT

A planar light source, which includes a first substrate, a plurality of electrode pairs, a second substrate, a plurality of side strips and a plurality of spacers, is disclosed. The electrode pairs are disposed on the first substrate. The second substrate is disposed above the first substrate. The side strips are disposed between the first substrate and the second substrate so that a discharge chamber is defined by the first substrate, the second substrate and the side strips. The spacers are disposed in the discharge chamber and serve as supporters between the first substrate and the second substrate. The spacers are disposed corresponding to the electrode pairs. A discharge gas is filled in the discharge chamber. The planar light source is easily to be produced and capable of reducing manufacturing cost.

### BACKGROUND OF THE INVENTION

1. Field of the Invention

The present invention relates to a planar light source and a liquid crystal display (LCD) apparatus. More particularly, the present invention relates to a planar light source packaged by utilizing side strips and a liquid crystal display utilizing the planar light source.

2. Description of Related Art

In recent years, the liquid crystal display panel is widely utilized in a plurality of apparatuses gradually. However, because the liquid crystal display panel can not self-luminesce, a back light module is required to provide light source behind the liquid crystal display panel so as to display images. Generally, the light source in the back light module is provided by a light tube. A planar light source adapted for emitting the liquid crystal display panel will be formed after the light emitted from the light tube passed through the optical films of the back light module and then are scattered.

And the more uniform planar light will be provided and the utilization efficiency of light will be further promoted by utilizing the planar light source directly. So the planar light source not only can be applied to the back light source of the liquid crystal display panel, but also can be applied to many other technology fields. Therefore, the planar light source has its advantages for developing.

Generally speaking, the planar light source is a kind of plasma luminescent elements. Its luminescence principle includes the following steps. First, a high voltage difference is applied between electrode pairs to produce high energy electrons. Next, the inert gas between anode and cathode in the discharge chamber will be bombarded into a plurality of excited gas molecules, ions and electrons by the high energy electrons, wherein the high energy excited gas molecules, ions and electrons are called plasma. And then, the excited atoms in plasma will release energy via emitting ultraviolet. Afterwards, the emitted ultraviolet will further excite the fluorescence powders in the cold cathode planar light to emit visible light.

FIG. 1 is a schematic view of a conventional planar light source. Referring to FIG.1, the conventional planar light source 100 comprises a substrate 110, a plurality of electrode pairs 120, a substrate 130, a frame 140 and a plurality of spacers 150. The electrode pairs 120 are disposed on the substrate 110. The substrate 130 is disposed above the substrate 110. The frame 140 is located between the substrates 110 and 130 so that a discharge chamber 160 is defined and surrounded by the substrates 110 and 130 and the frame 140. The spacers 150 are disposed between the substrates 110 and 130 to support them. And a discharge gas is filled in the discharge chamber 160.

Referring to FIG. 1, the discharge chamber 160 is a space surrounded by the frame 140 and two substrates 110 and 130, wherein the frame 140 formed in integral is fabricated by cutting or molding. For example, if the frame 140 is fabricated by cutting, it includes the following steps. First, a complete piece of substrate is provided. And then, a portion of the substrate is cut out to form the frame 140, so a material of the portion of the substrate will be wasted. In addition, if the frame 140 is fabricated by molding, it required a mold to pour the high-temperature melted glass therein to form the frame 140, so the purchase cost of apparatus (mold) will be increased by molding. To sum up, whether the frame 140 is fabricated by cutting or molding, the manufacturing cost of the planar light source 100 utilized the frame 140 will be increased.

Furthermore, a plurality of spacers 150 are required to be disposed between the substrates 110 and 130 to support them. But, the manufacturing process, a plurality of spacers 150 formed between the substrates 110 and 130, is complicated and time wasting.

### SUMMARY OF THE INVENTION

Accordingly, the present invention is directed to a planar light source easily to be produced and capable of reducing manufacturing cost.

The present invention is also directed to a liquid crystal display apparatus easily to be produced and capable of reducing manufacturing cost.

According to an embodiment of the present invention, the planar light source is disclosed. It comprises a first substrate, a plurality of electrode pairs, a second substrate, a plurality of side strips and a plurality of spacers. The electrode pairs are disposed on the first substrate. The second substrate is disposed above the first substrate. The side strips are disposed between the first substrate and the second substrate so that a discharge chamber is defined and surrounded by the first substrate, the second substrate and the side strips. The spacers are disposed in the discharge chamber and serve as supporters between the first substrate and the second substrate. The spacers are disposed corresponding to the electrode pairs. And a discharge gas is filled in the discharge chamber.

According to an embodiment of the present invention, the side strips are four rectangular side strips or four cylindrical side strips.

According to an embodiment of the present invention, the spacers comprise a plurality of pillar-shaped spacers, which are disposed between the first substrate and the second substrate.

According to an embodiment of the present invention, the spacers comprise a plurality of strip-shaped spacers, which are disposed between the first substrate and the second substrate, wherein the strip-shaped spacers are disposed corresponding to the electrode pairs in a parallel angle or in a vertical angle and the strip-shaped spacers are cylindrical spacers or rectangular strip-shaped spacers. A width of each strip-shaped spacer is from 0.5 mm to 10 mm, and the distance between two adjacent strip-shaped spacers is an integral multiple of the distance between two adjacent electrode pairs.

According to an embodiment of the present invention, a height of each strip-shaped spacer is from 0.1 mm to 10 mm.

According to an embodiment of the present invention, the material of the side strips and the spacers are glass, for example.

According to an embodiment of the present invention, the planar light source further comprises a fluorescent powder, disposed on surfaces of the spacers.

According to an embodiment of the present invention, the discharge gas is an inert gas, wherein the inert gas is selected from one of xenon, neon, argon and the combination thereof.

According to an embodiment of the present invention, a liquid crystal display apparatus is provided. The liquid crystal display apparatus comprises a liquid crystal display panel and a planar light source, wherein the planar light source is disposed behind the liquid crystal display panel and the planar light source is the same as aforementioned planar light source.

To sum up, the planar light source is packaged by utilizing side strips, whose manufacturing cost is less than that of hollow frame, so as to simplify the manufacturing process of planar light source and reduce manufacturing cost thereof. In addition, compared to the pillar-shaped spacers utilized in prior art, because the strip-shaped spacers are utilized in the present invention, the manufacturing process of the planar light source will be simplified and the manufacturing time thereof will be decreased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional planar light source.

FIGS. 2A and 2B are schematic views of planar light sources according to two embodiment of the present invention.

FIGS. 3A and 3C are schematic views of planar light sources according to three embodiment of the present invention.

FIGS. 4A to 4C are schematic views of the corresponding locations of the spacers and the electrode pairs.

FIG. 5 is a schematic view of a liquid crystal display apparatus according to one embodiment of the present invention.

### DESCRIPTION OF THE EMBODIMENTS

Various specific embodiments of the present invention are disclosed below, illustrating examples of various possible implementations of the concepts of the present invention. The following description is made for the purpose of illustrating the general principles of the invention and should not be taken in a limiting sense. The scope of the invention is best determined by reference to the appended claims.

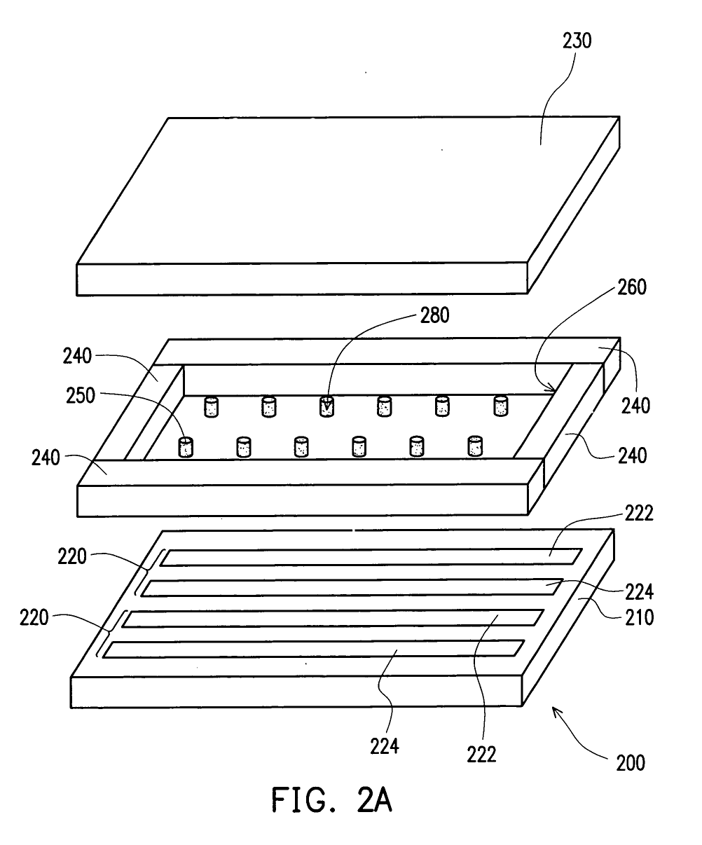

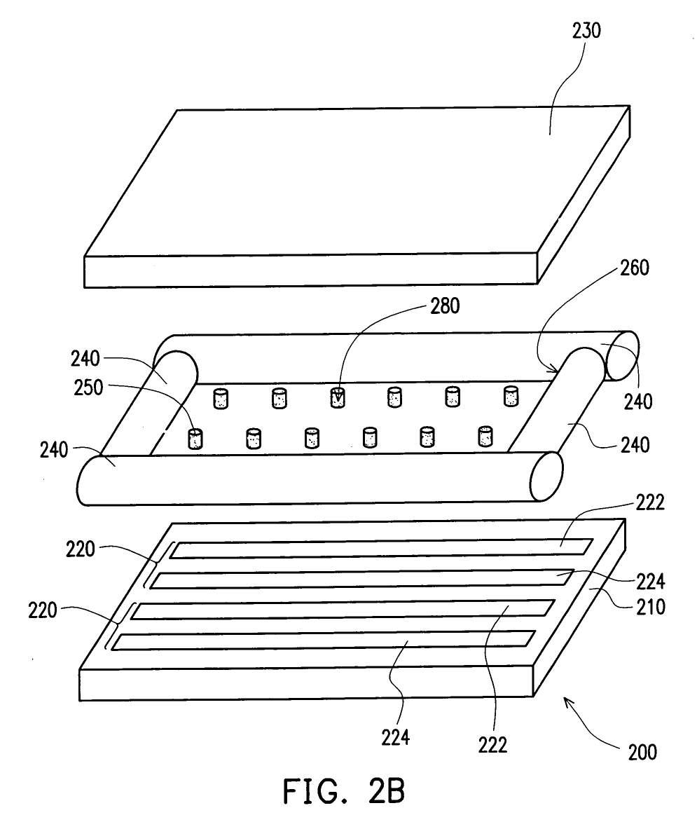

FIG. 2A is a schematic view of a planar light source according to one embodiment of the present invention. Referring to FIG. 2A, the planar light source 200 comprises a substrate 210, a plurality of electrode pairs 220, a substrate 230, a plurality of side strips 240 and a plurality of spacers 250.

Referring to FIG. 2A, the electrode pairs 220 are disposed on the substrate 210. The substrate 230 is disposed above the substrate 210. The side strips 240 are disposed between the substrates 210 and 230 so that a discharge chamber 260 is surrounded and defined by the substrates 210 and 230 and the side strips 240. The spacers 250 are disposed in the discharge chamber 260 and are served as the supporters between the substrates 210 and 230 to support them. The spacers 250 are disposed corresponding to the electrode pairs 220. And a discharge gas (not shown) is filled in the discharge chamber 260.

Referring to FIG. 2A, in one embodiment, the material of the substrates 210 and 230 can be glass or quartz. Each of the electrode pairs 220 located on the substrate 210 is composed of a first electrode 222 and an second electrode 224. One first electrode 222 is arranged next to one second electrode 224, i.e. the first electrode 222 is located between two neighboring second electrodes 224, and then the discharge will occur between the first electrode 222 and the second electrode 224 in one electrode pair 220 or between one electrode 222 and one of the two neighboring second electrodes 224 in different electrode pairs 220. Therefore, the discharge gas located between the first electrode 222 and the second electrode 224 will be excited to produce plasma. The shapes of the first electrode 222 and the second electrode 224 can be strip-shaped shown in FIG. 2A or any other shapes, in other words, the shapes of the electrode pairs 220 are not limited in the present invention.

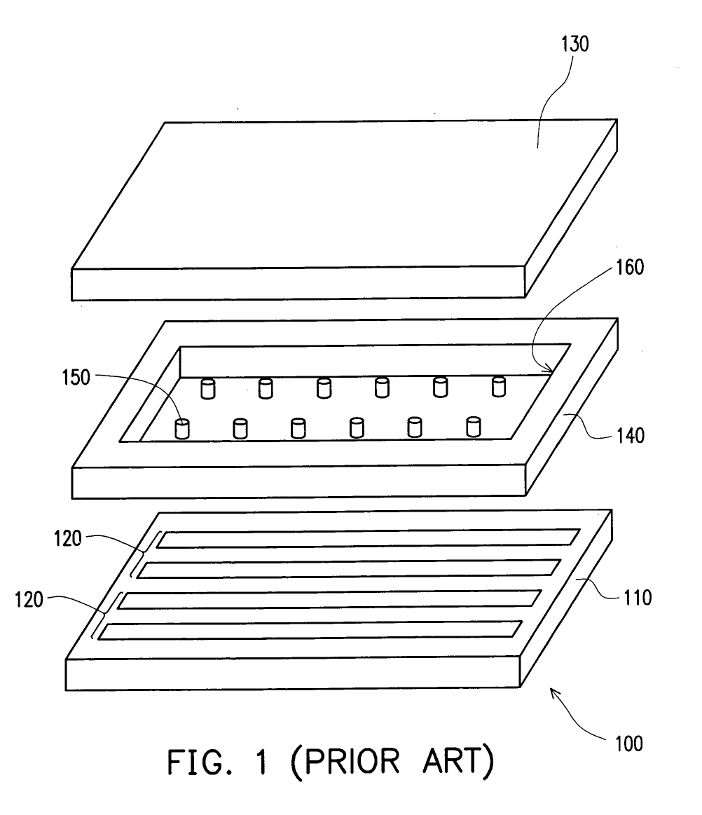

It should be noted that the side strips 240 not only can be four rectangular side strips shown in FIG. 2A, but also can be four cylindrical side strips shown in FIG. 2B in another embodiment. And the planar light source 200 will be packaged by utilizing the aforementioned rectangular side strips or cylindrical side strips. Compared to the conventional frame 140 (as shown in FIG. 1), the method for packaged the planar light source 200 by four side strips 240 in the present invention is more simple, because the method for fabricated the frame 140 by cutting or molding and then to package the planar light source 100 in prior art is more complicated. Therefore, the present invention has several advantages, i.e. simpler manufacturing process and lower manufacturing cost, because a frame can be fabricated by simply utilizing and assembling the side strips 240.

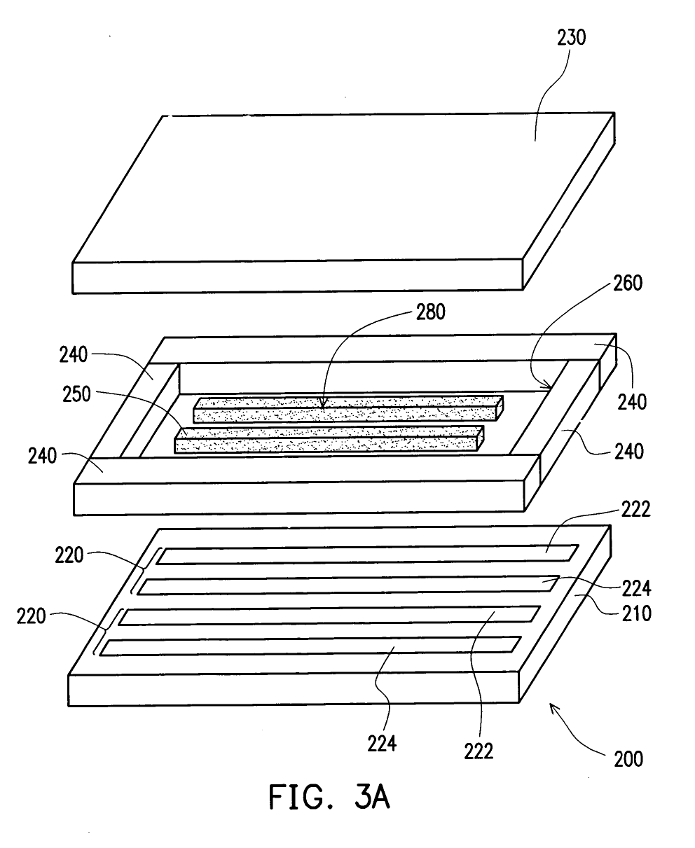

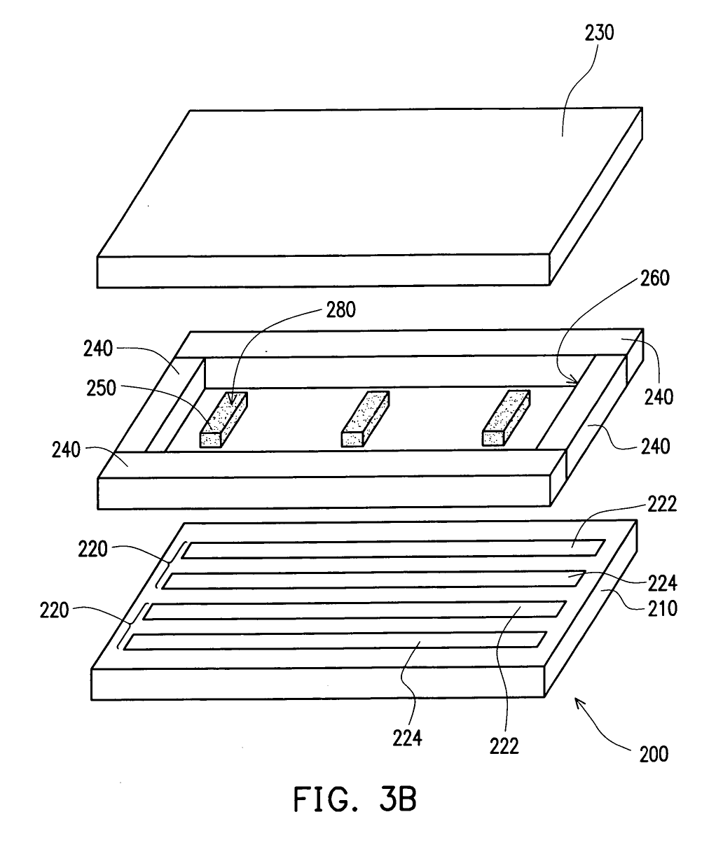

Referring to FIGS. 2A and 2B, the spacers 250 can be a plurality of pillar-shaped spacers, which are disposed between the substrates 210 and 230. In addition, in another embodiment, the spacers 250 can also be a plurality of strip-shaped spacers (shown in FIG. 3A), which are disposed between the substrates 210 and 230. Referring to FIGS. 3A and 3B, the strip-shaped spacers 250 are disposed corresponding to the electrode pairs 220 in a parallel angle (shown in FIG. 3A) or in a vertical angle (shown in FIG. 3B).

In addition, the strip-shaped spacers 250 can be not only rectangular strip-shaped spacers shown in FIGS. 3A and 3B, but also cylindrical spacers shown in FIG. 3C in another embodiment. A width of each strip-shaped spacer 250 shown in FIGS. 3A, 3B and 3C is from 0.5 mm to 10 mm and a height of each strip-shaped spacer 250 is from 0.1 mm to 10 mm, for example. It should be noted that the shape arrangement of the side strips 240 and the spacers 250 includes that both of them can be rectangular strip-shaped (as shown in FIGS. 3A and 3B) or cylindrical (as shown in FIG. 3C) or that one of them is rectangular strip-shaped and another is cylindrical. And the material of the side strips 240 and the spacers 250 can be glass.

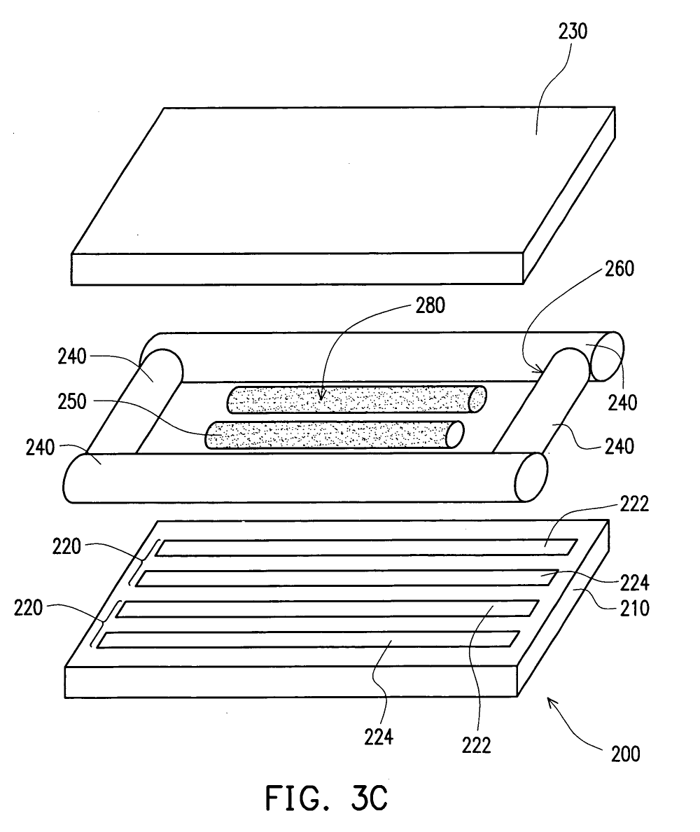

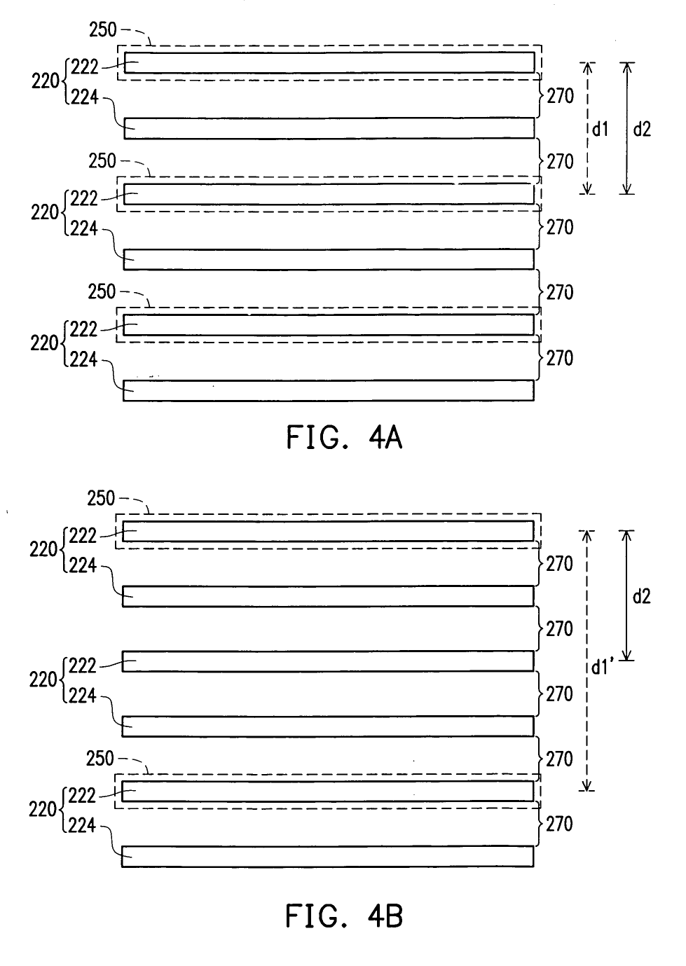

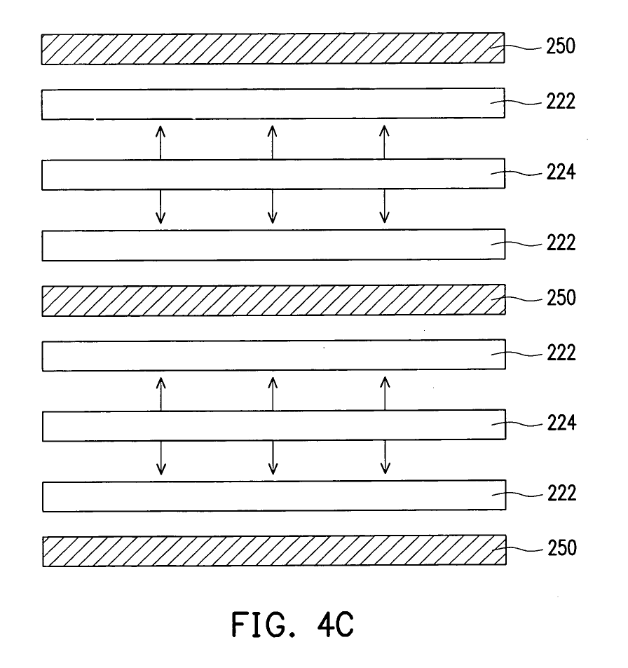

FIGS. 4A to 4C are schematic views of the corresponding locations of the spacers and the electrode pairs. Referring to FIGS. 4A and 4B, the distance between two adjacent strip-shaped spacers 250 is an integral multiple of the distance between two adjacent electrode pairs 220. In one embodiment, as shown in FIG. 4A, the distance d1 between two adjacent strip-shaped spacers 250 is equal to the distance d2 between two adjacent electrode pairs 220. In another embodiment, as shown in FIG. 4B, the distance d1′ between two adjacent strip-shaped spacers 250 is two multiples of the distance d2 between two adjacent electrode pairs 220.With reference to FIG. 4C, the combination, i.e. one second electrode 224 and two first electrodes 222, is utilized to generate the discharge between one second electrode 224 and one of two neighboring first electrodes 222. Because the discharge will not occur between two neighboring first electrodes 222, the strip-shaped spacer 250 can be disposed between two neighboring first electrodes 222 shown in FIG. 4C.

Generally, the distance between two adjacent spacers 250 is designed according to the dimension of the planar light source and the required forces to support these two substrates. In other words, if the dimension of the planar light source is bigger, the more forces are required to support these two substrates and then the more number of spacers 250 are required. Hence, the distance between two adjacent spacers 250 will be shorter (as shown in FIG. 4A). Contrarily, if the dimension of the planar light source is smaller, the fewer forces are required to support these two substrates and then the fewer number of spacers 250 are required. So the distance between two adjacent spacers 250 will be longer (as shown in FIG. 4B).

Referring to FIGS. 4A and 4B, the strip-shaped spacers 250 are disposed corresponding to the first electrodes 222. In addition, the strip-shaped spacers 250 can be also disposed corresponding to the second electrodes 224. Noticeably, not to influence the light emitted form the discharge area 270 between the first electrodes 222 and the second electrodes 224, the strip-shaped spacers 250 should not be disposed on the discharge area 270. Referring to FIG. 4C, the strip-shaped spacers 250 can not be disposed on the first electrodes 222 and the second electrodes 224 correspondingly, and the first electrodes 222, the second electrodes 224 and the strip-shaped spacers 250 can be disposed by arrangement shown in FIG. 4C.

The manufacturing process of the planar light source can be simplified and time-saving by utilizing strip-shaped spacers in the planar light source because the strip-shaped spacers can be fabricated more easily than the pillar-shaped spacers. In addition, the discharge chamber can also be divided into a plurality of discharge areas 270 shown in FIG. 4A, so that the discharge areas will not interfere with each other.

Referring to FIG. 2A, in one embodiment, the aforementioned planar light source 200 further comprises a fluorescent powder 280 disposed on surfaces of the spacers, for example. Compared to the pillar-shaped spacers 150 in prior art (as shown in FIG. 1), because the shape of spacers 250 can be strip-shaped in the present invention and the strip-shaped spacers 250 have bigger surface area, the area for disposing the fluorescent powder 280 will be increased so as to enhance the luminous efficiency.

In addition, in one embodiment, the discharge gas filled in the discharge chamber 260 can be an inert gas, which is selected from one of xenon, neon, argon and the combination thereof, for example. The lifespan for using the planar light source 200 will be prolonged because the inert gas does not react with the fluorescent powder 280 comparatively.

To sum up, the above-mentioned planar light source is packaged by using the side strips, so the planar light source is produced more easily and capable of reducing manufacturing cost. In addition, the planar light source can be applied in a plurality of fields, i.e. the back light module of the liquid crystal display apparatus, for example.

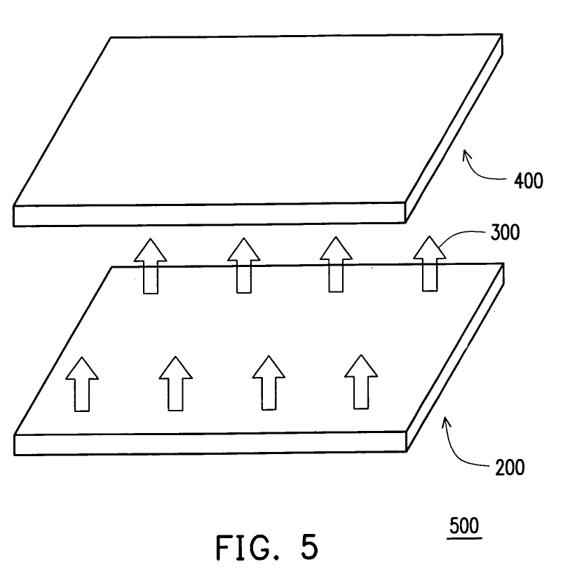

FIG. 5 is a schematic view of a liquid crystal display apparatus according to one embodiment of the present invention. Referring to FIG. 5, the liquid crystal display apparatus 500 includes a liquid crystal display panel 400 and a planar light source 200, wherein the planar light source 200 is disposed behind the liquid crystal display panel 400 and the planar light source 200 can be the same as aforementioned planar light source 200. The liquid crystal display panel 400 will have a better display effectiveness because the planar light source 200 is produced more easily and capable of reducing manufacturing cost to provide a better plane light source 300. The structures of the planar light source 200 have been illustrated in afore-mentioned embodiment, so not recited repeatedly again.

Additionally, in one embodiment, the liquid crystal display panel 400 comprises an active element array substrate, a color filter and a liquid crystal layer (all are not shown), for example. The active element array substrate has a plurality of active elements such as thin film transistors (not shown). A plurality of color filter films, such as the combination of red color filter films, green color filter films and blue color filter films, are arranged on the color filter to display colorful. The liquid crystal layer is disposed between the active element array substrate and the color filter. The optical characteristics of the liquid crystal layer will be changed while an electrode layer on the active element array substrate and the common electrodes on the color filter are interacted with each other that enables the liquid crystal molecules located between the active element array substrate and the color filter to twist.

In summary, the present invention, the planar light source and the liquid crystal display (LCD), have the following advantages:

(1). In contrast to conventional method for packaging the planar light source by the frame, the present invention utilizes four side strips for packaging the planar light source so as to be produced more easily and capable of reducing manufacturing cost.

(2). Because the discharge chamber can be divided into a plurality of discharge areas by utilizing the strip-shaped spacers as supporters between two substrates, the discharge areas will not be interfered with each other so as to enhance the luminous efficiency.

(3). Because the fluorescent powders can be disposed on surfaces of the strip-shaped spacers whose surface areas are larger, the luminous efficiency will be further enhanced.

The above description provides a full and complete description of the embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A planar light source, comprising:
a first substrate, wherein a plurality of electrode pairs are disposed on the first substrate;
a second substrate, disposed above the first substrate;
a plurality of side strips, disposed between the first substrate and the second substrate, wherein a discharge chamber is defined by the first substrate, the second substrate and the side strips; and
a plurality of spacers, disposed in the discharge chamber and serve as supporters between the first substrate and the second substrate, wherein the spacers is disposed corresponding to the electrode pairs and a discharge gas is filled in the discharge chamber.

2. The planar light source of claim 1, wherein the side strips comprise four rectangular side strips or four cylindrical side strips.

3. The planar light source of claim 1, wherein the spacers comprise a plurality of pillar-shaped spacers, disposed between the first substrate and the second substrate.

4. The planar light source of claim 1, wherein the spacers comprise a plurality of strip-shaped spacers, disposed between the first substrate and the second substrate.

5. The planar light source of claim 4, wherein the strip-shaped spacers are disposed corresponding to the electrode pairs in a parallel angle.

6. The planar light source of claim 4, wherein the strip-shaped spacers are disposed corresponding to the electrode pairs in a vertical angle.

7. The planar light source of claim 4, wherein the strip-shaped spacers are cylindrical spacers or rectangular strip-shaped spacers.

8. The planar light source of claim 4, wherein a width of each strip-shaped spacer is from 0.5 mm to 10 mm.

9. The planar light source of claim 4, wherein a distance between two adjacent strip-shaped spacers is an integral multiple of a distance between two adjacent electrode pairs.

10. The planar light source of claim 1, wherein a height of each strip-shaped spacer is from 0.1 mm to 10 mm.

11. The planar light source of claim 1, wherein a material of the side strips and the spacers comprises glass.

12. The planar light source of claim 1, further comprising a fluorescent powder, disposed on surfaces of the spacers.

13. The planar light source of claim 1, wherein the discharge gas is an inert gas.

14. The planar light source of claim 13, wherein the inert gas is selected from one of xenon, neon, argon and the combination thereof.

15. A liquid crystal display apparatus, comprising:
a liquid crystal display panel; and
a planar light source, disposed behind the liquid crystal display panel, wherein the planar light source is the same as recited in claim 1.

16. The liquid crystal display apparatus of claim 15, wherein the side strips comprise four rectangular side strips or four cylindrical side strips.

17. The liquid crystal display apparatus of claim 15, wherein the spacers comprise a plurality of pillar-shaped spacers, disposed between the first substrate and the second substrate.

18. The liquid crystal display apparatus of claim 15, wherein the spacers comprise a plurality of strip-shaped spacers, disposed between the first substrate and the second substrate.

19. The liquid crystal display apparatus of claim 18, wherein the strip-shaped spacers are cylindrical spacers or rectangular strip-shaped spacers.

20. The liquid crystal display apparatus of claim 18, wherein a distance between two adjacent strip-shaped spacers is an integral multiple of a distance between two adjacent electrode pairs.
